(19) United States
(12) Patent Application Publication
(10) Pub. No.: US 2013/0011595 A1
(43) Pub. Date: Jan. 10, 2013

(54) NYLON AIRBRAKE TUBING CONSTRUCTIONS

(75) Inventor: Nicola Martino, Wadsworth, OH (US)

(73) Assignee: PARKER-HANNIFIN CORPORATION, Cleveland, OH (US)

(21) Appl. No.: 13/636,344

(22) PCT Filed: Mar. 3, 2011
(86) PCT No.: PCT/US11/26967

§ 371 Date: Sep. 21, 2012

Related U.S. Application Data
(60) Provisional application No. 61/329,342, filed on Apr. 29, 2010.
(60) Provisional application No. 61/446,863, filed on Feb. 25, 2011.

(51) Int. Cl. B32B 1/08; F16L 9/14; B32B 5/22; B32B 27/08; B32B 15/08

(52) U.S. Cl. 428/35.8; 428/36.9; 428/36.91; 428/36.4; 138/140

(57) ABSTRACT

Single or multilayer tube such as for use as airbrake tubing. At least one of the layers of the tube may be formed of a long-chain polyamide such as nylon 4-10, nylon 6-10, nylon 10-10, nylon 6-12, nylon 10-12, or nylon 12-12, or an alloy thereof.

### CROSS-REFERENCE TO RELATED CASES

The present application claims the benefit of the filing date of U.S. Provisional Application Ser. No. 61/329,342, filed Apr. 29, 2010, and U.S. Provisional Ser. No. 61/446,863, filed Feb. 25, 2011, the disclosures of which are expressly incorporated herein by reference.

### BACKGROUND OF THE INVENTION

The present invention relates broadly to tubular nylon members and to articles such as single or multi-layer tubing, which may be straight or coiled, constructed thereof, and more particularly to such members and to such articles for use as airbrake tubing.

Tractor/trailer rigs and other heavy-duty vehicles are conventionally are equipped with pneumatically-operated emergency brakes in addition to usual service airbrakes. In basic operation, and as is further described in U.S. Pat. No. 5,232,645 and U.K. Pat. Appln. GB 2,239,503, pressurized air is supplied from the truck unit to the trailer unit, which may be articulated, for the actuation of the emergency and service brake systems of the trailer. Within the emergency brake system, the braking mechanism normally is released under the condition of a constant air pressure supply. The service brake system, however, is manually actuated with pressurized air being supplied to the breaking mechanism upon the application of the brake pedals by the operator.

Pressurized air from the truck to the trailer unit, or between trailer units in tandem rigs, may be supplied via flexible tubing or hose, with separate, dedicated lines being provided for the independent operation of the emergency and service brake systems. Performance requirements for airbrake tubing generally are subject to various governmental or industry regulations promulgated to ensure the safe operation of the vehicle. In this regard, airbrake tubing conventionally is constructed as having tubular core which optionally may be surrounded, in certain tubing types, by one or more layers of a braided or other wound reinforcement. The core tube may be a thermoplastic material such as a polyamide, polyolefin, polyvinyl chloride, or polyurethane, or a synthetic rubber material such as Buna N or neoprene, with the optional reinforcement preferably being a nylon, polyester, or aramid filament or yarn. For increased abrasion resistance, the core tube and, as the case may be, reinforcement typically are covered with an outer jacket which may be formed of the same or different material as the core tube, but preferably is formed of more abrasion-resistance polymeric material which may be a polyamide, polyolefin, polyvinyl chloride, or polyurethane. Representative airbrake and other tubing constructions, and coils and bundles formed of such tubing, are described in U.S. Pat. Nos. 6,776,195; 6,670,004; 6,576,312; 6,354,331; 6,098,666; 6,071,579; 6,066,377; 5,392,541; 5,232,645; 4,653,541; 4,009,734; 3,977,440; and RE38,087, U.S. Pat. Appln. Publ. Nos. 2009/0017244; 2007/0087150; 2006/0280889; 2004/0134555; and 2003/0145896, and WO 2004/026571. Commercial airbrake tubing and coils are manufactured and sold by the Parflex Division of Parker-Hannifin Corp., Ravenna, Ohio, as well as others.

Other tubing constructions, such as multi-layer constructions used for fuel line applications, incorporate a bonding or tie layer between an inner fluoropolymer layer or liner and a second layer of a stronger, tougher, and, typically, less-expensive material, such as a nylon, polyamide, or polyurethane, which is used as a reinforcement or cover for the liner. The tie layer, which may be formed as a co- or tri-extrusion with the liner and second layers, is formulated to be compatible chemically with both the fluoropolymer material of the liner and the material of the second layer such that a thermal fusion bond may be achieved between the liner and tie layer and the tie layer and second layer to thereby consolidate the tubing into an integral structure. The use of such tie layers dictates the selection of specific materials for the liner and second layer so as to be compatible with the material of the tie layer, or vice versa, and is believed limited to the use of melt processible fluoropolymers such as polyvinylidene fluoride (PVDF) or ethylene tetrafluoroethylene (ETFE). Multi-layer tubing constructions are shown, for example, in U.S. Pat. Nos. 6,670,004; 6,066,377; 6,041,826; 6,039,085; 6,012,496; 5,996,642; 5,937,911; 5,891,373; 5,884,672; 5,884,671; 5,865,218; 5,743,304; 5,716,684; 5,678,611; 5,570,711; 5,566,720; 5,524,673; 5,507,320; 5,500,263; 5,480,271; 5,469,892; 5,460,771; 5,419,374, 5,383,087; 5,284,184; 5,219,003; 5,167,259; 5,167,259; 5,112,692; 5,112,692; 5,093,166; 5,076,329; 5,076,329; 5,038,833; 5,038,833; 4,706,713; 4,627,844; and 3,561,493, in German Pat. Publ. Nos. DE 3942354 and 3821723, in Japanese Pat. Publ. Nos. JP 61171982; 4224939; and 140585, in European Pat. Publ. Nos. EP 1002980, 992518, and 551094, in International (PCT) Publ. Nos. WO 99/41538; 99/41073; 97/44186; and 93/21466, and in U.K. Pat. Publ. No. GB 2204376.

It is believed that alternative single and multi-layer tubular polymeric members would be useful for airbrake tubing applications, as well as in a variety of other fluid transfer and motion control applications. In this regard, in severe or even normal service environments, such as in mobile or industrial pneumatic or hydraulic applications, hoses and tubing of the type herein involved may be exposed to a variety of environmental factors and mechanical stresses that cannot always be predicted. Current commercial airbrake tubing constructions, which may be single or multi-layer and reinforced or unreinforced, are made from materials such as copolyester and copolyester blends, nylon 11 and nylon 12, and modified nylon 6 or alloys of nylon 6 and nylon 12 with an outer layer of nylon 12. Modified or unmodified nylon 6, 6-6, 6/6-6 are unsuitable for use throughout the wall of an airbrake construction due to poor resistance to heavy metal salts such as zinc chloride and calcium chloride. The use of an outer layer of nylon 11, 12, or 6-12 is employed to protect the lower-cost nylon 6, 6-6, or 6/6-6 layers. It is anticipated tube constructions which offer comparable performance, but which are more economical would be well-received by manufactures of heavy trucks and other vehicles which utilize airbrake tubing.

### BROAD STATEMENT OF THE INVENTION

The present invention is directed to tubular polymeric members, which may formed by extrusion, co-extrusion, or molding, and articles such as mono- or multi-layer tubing and hoses, which may be straight or coiled, constructed thereof. More particularly, the invention is directed to such members having at least one layer which is formed of a “long-chain” polyamide condensation polymer such as 4-10, nylon 6-10, nylon 10-10, nylon 6-12, nylon 10-12, or nylon 12-12, or a copolymer, alloy, blend, or other combination thereof. Such materials combine the low moisture absorption and good chemical and heavy-metal salt resistance properties of longer-chain, i.e., “higher,” nylons such as nylon 11 or 12, with the higher melting point and crystallization rates of shorter-chain, i.e., “lower,” polyamides such as nylon 4, 6, or 4-6, which may provide higher temperature resistance when used in airbrake tubes or other applications having similar environments. In single wall tubes, these materials may be used throughout the tube cross-section to provide a simpler, single-resin construction. In multi-wall tubes, these materials otherwise provide for a more economical construction.

The tubing members formed in accordance with the precepts of the present of the invention may be particularly adapted for use as single or multi-layer tubing for vehicular airbrake systems, and/or as a core tube or other element in a reinforced tubing and hose constructions, as well as in other applications requiring chemical resistance and/or compliance with industry or governmental standards. Typically in such constructions, the more chemically or environmentally-resistant layers such as the tubing member of the invention are provided as an innermost and/or outermost layer of the structure. In reinforced constructions, such member may be used as a core tube over which one or more layers of a fibrous reinforcement layer are braided or wound to provide resistance to internal or external pressures. Alternatively, such member may be used as an outer layer over the reinforcement layers.

Heretofore in the North American heavy duty truck market constructions for reinforced airbrake tubing typically have utilized either two relatively expensive polyamide 11 or 12 layers bonded together through the interstices of an open, spiral wound polyester or nylon fiber reinforcement or a less expensive modified nylon 6 or nylon 6-6 layer interposed between two thinner layers of nylon 11 or 12. In the latter construction, the nylon 6 or 6-6 layer may be bonded to the nylon 11 or 12 layers by an intermediate layer of nylon 6-12 or an anhydride-modified polyolefin tie layer. Although the nylon 6 or 6-12 layer can be impact modified and plasticized to make it more useful as an airbrake tubing material, it nonetheless is highly susceptible to stress cracking when contacted with zinc chloride and loses physical properties when saturated with water, thus the need to protect it by laminating it between layers of nylon 11 or 12. However, should the relatively thin nylon 11 or 12 layers be abraded, the inner nylon 6 or 6-6 layer may be exposed whereupon it is susceptible to stress cracking by contact with zinc chloride, such as may be found in road salt is used to melt ice and snow or near the marine environments. Moreover, when cut the ends of such tubing has exposed nylon 6 or 6-6 and also may be are in constant contact with fittings having a zinc coating or other zinc content which can form zinc chloride when coming into contact with road salt.

The tubing construction of the present invention therefore contemplates an improved yet economical mono- or multi-layer airbrake tubing construction which utilizes a more zinc chloride and other heavy-metal resistant “long-chain” polyamide layer which optionally may be joined to an outer layer of another polyamide such as nylon 11 or 12 or another material. As such layer is more salt and high-temperature resistant than a nylon 6-based layer, an improved tubing construction can result.

The present invention, accordingly, comprises the materials, process, and the articles constructed which are exemplified in the detailed disclosure to follow. Advantages of the present invention include a tubular nylon alloy member which may be used alone as tubing or as core tube for hose, and which provides improved physical properties and chemical resistance as compare to nylon 6 or 6/6 materials. Additional advantages include a tubing construction which is economical to manufacture, and which may meet applicable DOT and SAE standards for airbrake tubing and coils such as SAE Standard J844, “Nonmetallic Airbrake System Tubing,” (June 1998), SAE Standard J2484, “Push-To-Connect Tube Fittings for Use in the Piping of Vehicular Airbrake,” (May 2000), and SAE Standard J1131, “Performance Requirements for SAE J844 Nonmetallic Tubing and Fitting Assemblies Used in Automotive Airbrake Systems,” (August 1998), and NHSA/DOT FMVSS 106 (49 CFR §571.106). These and other advantages should be apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a perspective cut-away view of a representative tube construction according to the present invention;

FIG. 2 is a radial cross-sectional view of the tube construction of FIG. 1 taken through line 2-2 of FIG. 1;

FIG. 3 is a perspective cut-away view of another representative multi-layer tube construction according to the present invention;

FIG. 4 is a radial cross-sectional view of the tube construction of FIG. 3 taken through line 4-4 of FIG. 3;

FIG. 5 is a perspective cut-away view of another representative multi-layer tube construction according to the present invention; and

FIG. 6 is a radial cross-sectional view of the tube construction of FIG. 5 taken through line 6-6 of FIG. 5.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,” “outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense. In certain views of the figures, the axial direction may be shown by an arrow labeled “A,” and the radial direction may be shown by an arrow labeled “R.”

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

The term “thermoplastic material” may be used herein interchangeably with “melt processible material,” and is in contrast to non-melt processible materials such as thermosets or non-thermosetting materials which otherwise exhibit a melt viscosity that is sufficiently high so as to preclude flow and processing by conventional melt extrusion or molding operations, and therefore necessitating that the material be processed using sintering or solvent processing techniques. Such materials, which may be referred herein as “resins,” typically will have a melting point of between about 110-230° C., and a thermal decomposition temperature, which defines the upper processing limit of the resin, of between about 150-260° C. The term “melting point” as used herein may be a transition from a form-stable crystalline or glassy solid phase to a softened or otherwise viscous phase which may be generally characterized as exhibiting intermolecular chain rotation and, as between layers, chain diffusion and/or other intermingling. For amorphous or other thermoplastic resins not having a clearly defined melting peak, the term melting point is used interchangeably with glass transition or softening point.

The term “copolymer” is used herein in a general sense to include ter-polymers and higher polymers. In the interest of clarity, nylons are identified in the specification and claims using a “-” (a dash) to separate the number designation of, respectively, the amine and acid groups, and a “/” (a slash) to separate copolymer components. The terms “lower” or “short-chain” are used herein to mean a nylon or, interchangeably, polyamide based on nylon 4 or 6, or a copolymer, alloy, blend, or other combination thereof. Likewise, terms “higher” or “long-chain” are used herein to mean a nylon or, interchangeably, polyamide based on nylon 10, 11, or 12, or a copolymer, alloy, blend, or other combination thereof, or a copolymer, alloy, blend, or other combination thereof such a higher nylon with a lower nylon.

For the illustrative purposes of the discourse to follow, the precepts of the tube construction of the invention herein involved are described in connection with its utilization as flexible tubing, which may be straight or coiled, such as for vehicular airbrake applications. Various mono- or multi-layer constructions may be envisioned by balancing raw material costs with finished product performance and physical characteristics such flexibility, low temperature impact, high temperature burst strength, dimensional stability, and the like. It will be appreciated, however, that aspects of the present invention may find use in other tubing applications, such as in multiple tube bundles or as a core tube or other member within a flexible pressure or vacuum hose construction such as for hydraulic or pneumatic power, signaling, control, or general fluid transfer applications. Use within those such other applications therefore should be considered to be expressly within the scope of the present invention.

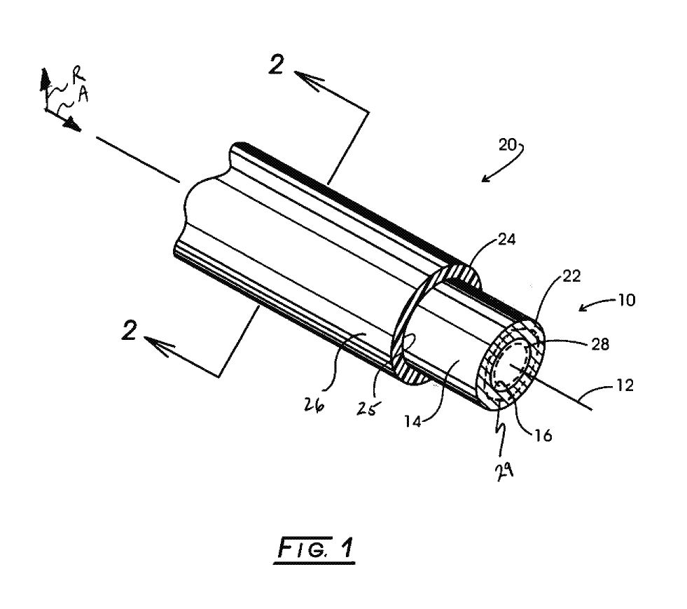

Referring then to the figures wherein corresponding reference characters are used to designate corresponding elements throughout the several views with equivalent elements being referenced with prime or sequential alphanumeric designations, a representative mono-wall tube in accordance with the present invention is referenced at 10 in the perspective cut-away view of FIG. 1 and, alternatively, as incorporated as a layer in a length of the multi-wall tube referenced generally at 20. In either embodiment, such tubes 10 and 20, which may be straight as shown or coiled, extend lengthwise along a central longitudinal axis, 12. In the embodiment shown, tube 10 has a circumferential outer surface, 14, and a circumferential inner surface, 16.

Tube or layer 10 may be extruded or otherwise fabricated, such as by molding, of a first thermoplastic material of a long-chain polyamide such as nylon 4-10, nylon 6-10, nylon 10-10, nylon 6-12, nylon 10-12, nylon 12-12, or a copolymer, blend, alloy, or other combination. Such long-chain polyamides are marketed commercially by BASF (Ludwigshafen, Germany) under the tradename “Ultramid Balance,” Dupont (Wilmington, Del.) under the tradename “Zytel,” and DSM Engineering Plastics (Sittard, The Netherlands) under the tradename “EcoPaXX.” The first thermoplastic material forming the tube or layer 10 may be blended, alloyed, or otherwise combined with a second material which may be a lower polyamide such as nylon 6, nylon 6-6, nylon 6/6-6, nylon 4/6, or a copolymer, blend, alloy, or other combination thereof. The second thermoplastic material, alternatively, may be a higher polyamide such as nylon 11 or 12. The alloy of the first and second thermoplastic materials may be formulated, exclusive of any fillers, modifiers, additives, or other component, as blended or otherwise admixed of, for example, between about 10-50% by weight of the first thermoplastic material, between about 50-90% by weight of the second thermoplastic material.

As mentioned, the first and second thermoplastic materials each themselves may be copolymers or blends of one or more homopolymers, one or more copolymers, or one or more homopolymers and one or more copolymers. Also, either of the materials or the alloy thereof may be may be unfilled or, alternatively, compounded with one or more fillers, modifiers, or other additives such as to improve low temperature impact resistance and/or resistance to heat or light. Such additives, which may be in liquid, powder, particulate, flake, fiber, or other form, may include compatibilizers, plasticizers, impact modifiers, electrically-conductive fillers, microwave-attenuating fillers, thermally-conductive fillers, lubricants, wetting agents, stabilizers, antioxidants, pigments, dyes, colorants, colorings, or opacifying agents such as for coloring-coding of the tubing, luminescents, light reflectants, chain extending oils, tackifiers, blowing agents, foaming or anti-foaming agents, reinforcements such as glass, carbon, or textile fibers, and fire retardants, metal oxides and salts, intercalated graphite particles, borates, siloxanes, phosphates, glass, hollow or solid glass or elastomeric microspheres, silica, silicates, mica, and the like. Typically, such additives may be blended or otherwise admixed with the alloy, and/or with one or more of the constituents thereof, and may comprise between about 0.1% and 80% or more by total weight or volume of the formulation.

As to the long-chain polyamide of the first thermoplastic material, such material, which may be plasticized or unplasticized, affords the tube or layer 10 with chemical resistance to swelling, crazing, stress cracking, and corrosion, and otherwise the capability to withstand attack from gasoline, diesel fuel, and other engine fluids or hydrocarbons, as well as organic solvents such as methanol, and inorganic solvents such as water or brine. The specific material or grade may be chosen for reasons of cost and/or for service temperature, chemical compatibility with the fluid being handled, fluid, solvent, moisture, or environmental resistance, flexural modulus, hardness, or other physical property, and typically will have a melting point of between about 175-235° C. and a thermal decomposition temperature of between about 195-280° C.

As to the polyamide for the second thermoplastic material, such material, which again may be plasticized or unplasticized, may be selected for reasons of cost and/or compatibility with the first thermoplastic material. Also, if the stiffness and low temperature impact resistance of the first thermoplastic material is such that it would have to be plasticized and/or impact modified to an extent which results in excessive softening that renders it undesirable for airbrake tubing applications, the use of a relatively soft higher polyamide, such as nylon 11 or 12, as the second thermoplastic material may reduce the level of plasticization or modification required, and may afford improved chemical resistance.

Should the selected first and second thermoplastic materials are incompatible, a compatibilizer may be admixed in the formulation. For the applications herein involved, such compatibilizers may include maleic anhydride-grafted olefins, or functionalized ethylene copolymers. If low temperature impact modification is required, such as to meet regulatory or performance requirements or cost constraints, impact modifiers and plasticizers such as modified or functionalized ethylene, acrylic, or EPDM polymers and copolymers also may be included in the formulation. Newer nanostructured alloys of nylon and olefins/ethylene copolymers, such as marketed by Arkema SA (Colombes, France) under the tradename “Apolhya,” also may find applicability as modifiers as having relatively high melting temperatures with the potential to improve impact resistance without significantly reducing resin strength, particularly at elevated temperatures.

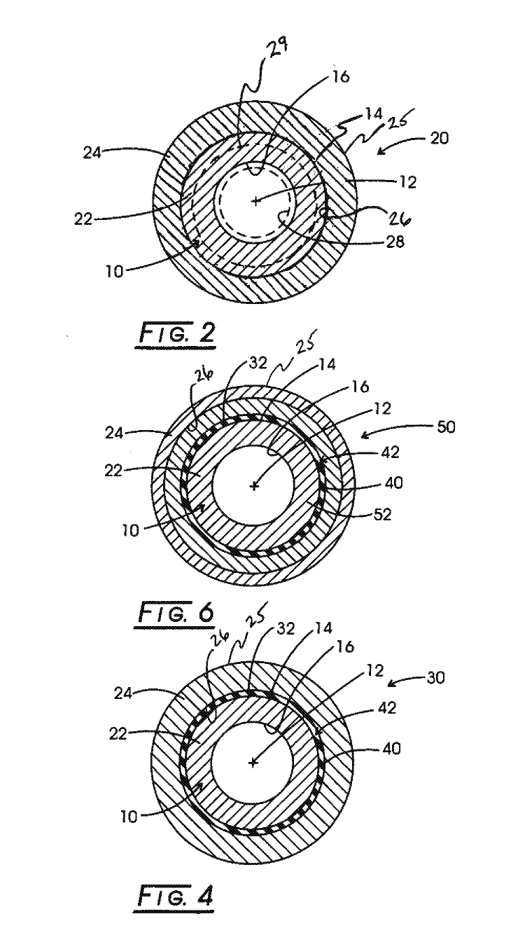

Looking now additionally to the radial cross-section view of FIG. 2, the illustrated multi-layer tube construction 20 incorporating layer 10 is shown to be formed as an unreinforced 2-layer laminate of a tubular first layer, 22, formed by the tube 10, and a tubular second layer, 24, which is concentric with the layer 22 and which itself may have an inner surface, 25, and an outer surface, 26. As shown, layer 24 may be the outermost layer of the construction 20 and layer 22 may be the innermost layer. Layer 24 may be formed of a thermoplastic polymeric material which may be formulated the same as or similar to the material of first layer 22. In this regard, such material forming layer 24 may be a long-chain polyamide such as nylon 4-10, nylon 6-10, nylon 10-10, nylon 6-12, nylon 10-12, nylon 12-12, or a copolymer, blend, alloy, or other combination. Such material also may be blended, alloyed, or otherwise combined with another thermoplastic material which may be a lower polyamide such as nylon 6, nylon 6-6, nylon 6/6-6, nylon 4/6, or a copolymer, blend, alloy, or other combination thereof, or a higher polyamide such as nylon 11 or 12. As before, such alloy of the thermoplastic materials may be formulated, exclusive of any fillers, modifiers, additives, or other component, as blended or otherwise admixed of, for example, between about 10-50% by weight of one of the materials, and between about 50-90% by weight of the other material.

Alternatively, layer 24 may be formed of a general purpose resin such as a polyester or polyurethane. For airbrake tubing applications, however, layer 24 may be a polyamide or blend, and particularly a polyamide of the type commonly used in such applications, such as a plasticized or unplasticized nylon which may be nylon 6, 6/6-6, 6-12, or, for chemical resistance, a higher nylon such as nylon 11 or 12. As before, the material forming the layer 24 may be filled or unfilled, and may be a homo or copolymer, or a blend thereof, i.e., a blend of one or more homopolymers, one or more copolymers, or one or more homopolymers and one or more copolymers.

As shown in phantom at 28, in the tube construction 20, as well as in any of the tube constructions herein involved, an innermost layer of thermoplastic polymeric material, which again may be a polyamide polymer, copolymer, or blend, and particularly a higher nylon such as nylon 11 or 12, may be provided. In such constructions, the layer 26 may form the innermost layer of the construction 20 such as to provide increased chemical resistance.

With the layers 22 and 24 each being formed of a thermoplastic material, the tubing construction 20 may be formed by continuous co-extrusion or other extrusion such as cross-head or sequential extrusion. The outer layer 24 may be colored by blending the resin thereof with a color concentrate to provide a color throughout the thickness of the layer, or by utilizing a thin co-extruded color skin at the die, or by dip coating or spray adhesion.

Alternatively, the layers 22 and 24 may be molded or co-molded, or otherwise formed, such as via coating, or a combination of extrusion, molding, and/or coating. If formed of compatible materials, the layers 22 and 24 may be directly bonded together, such as by thermal fusion bonding, to form an integral, composite or laminate structure. Otherwise, if adjoining, the layers may be made into a composite via the use of an intermediate adhesive, tie, or other layer (not shown). Indeed, in other multi-layer construction, one or more additional layers, which may be the same as or different than the layers 22 and 24, may be provided in combination with those layers. Also, in any of the constructions, the layers may be reversed such that the outer surface 14 of the layer 22 may form the outermost surface of the construction 20. As shown in phantom at 29 for layer 22, each of the layers in the tube construction 20, as well as in the as in any of the tube constructions herein involved, may be coextruded or otherwise formed in multiple layers having the same or different composition.

Depending on the requirements of the particular application, one or more reinforcement or additional resin layers, or a cover or jacket (not shown), may be knitted, braided, woven, wound, or wrapped in the case of a fiber, wire, metal foil, tape, film, or the like, or, alternatively, extruded, molded, or coated such as in the case of an additional resin layer resin layer, on or about, or otherwise as surrounding the construction 20 which, in such instance, may function as a core tube for such hose. The materials forming the reinforcement, cover, or additional resin layers may be loaded with metals, carbon black, pigments, dyes, reflectants or another fillers in particulate, flake, fiber, or other form so as to render the such construction electrically-conductive for applications requiring electrical conductivity or static dissipation, and/or, depending upon the filler, for providing color coding or increased visibility. Separate electrically-conductive or reflective fiber or resin layers, wires, and other elements (not shown) also may be incorporated within, in, or on the multi-layer structure of the construction 20 such as to provide electrical conductivity, static dissipation, or increased visibility.

The wall thicknesses of each of the layers 22 and 24 in the construction 20 may be of any thickness, both absolute and relative to the thickness of the other layer. For airbrake tubing applications, however, the wall thickness of the layer 22 typically may be between about 35-75% and, typically, between about 45-60% of the overall wall thickness of the tubing construction 20, with the balance thereof being comprised of the layer 24.

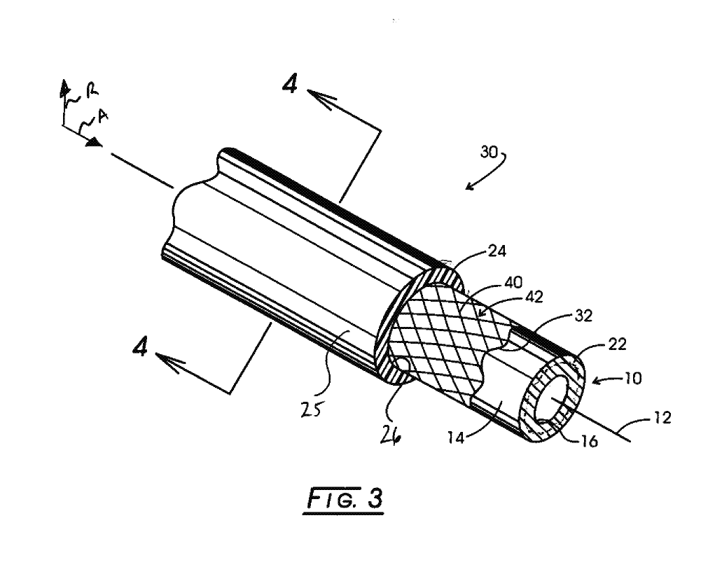

Turning next to the views of FIGS. 3 and 4, a representative 3-layer tubing construction incorporating tube 10 as the layer 22 of FIGS. 1 and 2 is referenced generally at 30. Such construction 30 is similar to that of the construction 20, with the exception that one or more reinforcement layers, 32, is interposed between the layers 22 and 24. As to the reinforcement, each of the one or more reinforcement layers 32 may be, depending upon the required degree of flexibility and/or for ease of manufacture, braided, woven, wound, such as spiral or helically, loomed, axially-oriented, knitted, wrapped, or otherwise formed successively about, i.e., as surrounding, outer surface 14 of the inner layer 22, with the outer layer 24 then being extruded or otherwise formed over the reinforcement layer or layers 32. Each of the reinforcement layers 32 may be formed, of one or more filaments, which may be monofilaments, continuous multi-filament, i.e., yarn, stranded, cord, roving, thread, tape, or ply, or short “staple” strands, of one or more fiber materials. The fiber material, which may be the same or different in each of the layers 32 which are provided, may be a natural or synthetic polymeric material such as a nylon, cotton, polyester, polyamide, aramid, polyolefin, polyvinyl alcohol (PVA), polyvinyl acetate, or polyphenylene bezobisoxazole (PBO), or blend, a steel, which may be stainless or galvanized, brass, zinc or zinc-plated, or other metal wire, or a bi- or multi-component blend thereof.

For airbrake tubing applications, and as is shown in FIG. 3, a single reinforcement layer 32 typically will be provided as braided of a nylon, polyester, or aramid filament or yarn, and may have a relatively open structure with interstices, one of which is referenced at 40, between the filaments, referenced at 42, of the braid. The outer layer 24 thereby may be fusion or otherwise bonded directly to the reinforcing layer 32 or, alternatively, to the inner layer 22 through the interstices 40. The reinforcement layer 32 itself may be bonded to or between the layers 22 and 24 mechanically, such as by embedded in or encapsulated between the layers 22 and 24, or by other bonding means such as fusion, chemical, or adhesive bonding, or a combination thereof or otherwise. Such other bonding means may be effected by solvating, tackifying, or plasticizing the surfaces of the layers 22 and/or 24 with an appropriate solvent, such as a carboxylic or other organic acid, tackifier, or plasticizer such as an aqueous or other solution of an amine such as n-methyl pyrrolidone or a phenol such as meta-cresol or resorcinol, or with the use of a urethane, epoxy, vinyl chloride, vinyl acetate, methyl acrylic, or other adhesive having an affinity to the materials forming the layers 22 and 24, or otherwise in the manner described, for example, in U.S. Pat. Nos. 3,654,967; 3,682,201; 3,773,089; 3,790,419; 3,861,973; 3,881,975; 3,905,398; 3,914,146; 3,982,982; 3,988,188; 4,007,070; 4,064,913; 4,343,333; 4,898,212; and 6,807,988 and in the references cited therein, and in Japanese (Kokai) Publ. No. 10-169854 A2 and Canadian Pat. No. 973,074. The one or more reinforcement layers 32 also be an oriented extrusion or other layer of fillers including foam, liquid crystal polymer (LCP), nanoclay, or a compatibilized nylon/PET blend.

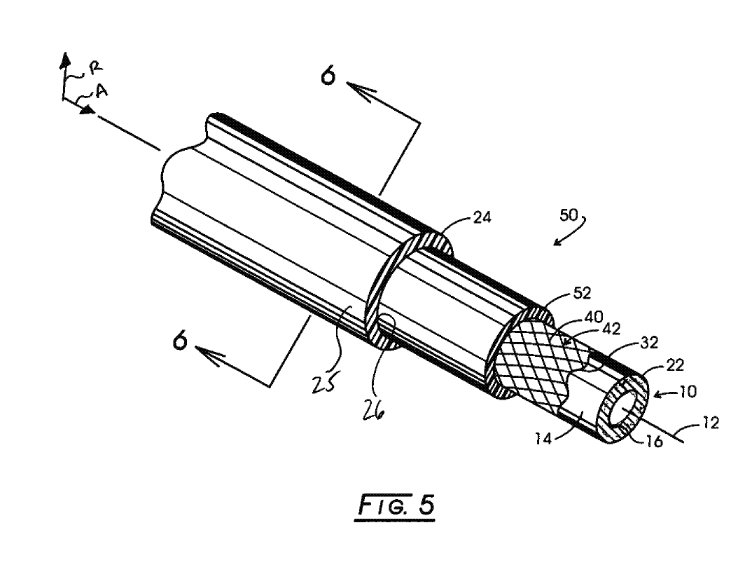

Looking lastly to the views of FIGS. 5 and 6, a representative 4-layer tubing construction generally at 50. Such construction 50 is similar to that of the construction 30, with the exception that and additional layer, 52, of the tube 10 of FIGS. 1 and 2 is interposed between the layers 32 and 24, and that the layer 24 being shown as being relatively thinner than in the construction 30. In such construction 50, the combined wall thicknesses of the layers 22 and 52 again may be between about 35-75% and, typically, between about 45-60% of the overall wall thickness of the tubing construction 50, with the balance thereof being comprised of the layer 24.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A tube comprising at least a tubular first layer, the first layer comprising a first thermoplastic material comprising a long-chain polyamide.

2. The tube of claim 1 wherein the long-chain polyamide is selected from the group consisting of nylon 4-10, nylon 6-10, nylon 10-10, nylon 6-12, nylon 10-12, nylon 12-12, and copolymers, blends, alloys, and combinations thereof.

3. The tube of claim 1 or 2 wherein the first layer further comprises a second thermoplastic material different from the first thermoplastic material and blended therewith to form an alloy, the second thermoplastic material comprising a lower nylon polymer or copolymer.

4. The tube of claim 3 wherein the lower nylon polymer or copolymer is selected from the group consisting of nylon 6, nylon 6-6, nylon 6/6-6, nylon 4/6, and copolymers, blends, alloys, and combinations thereof.

5. The tube of claim 1 or 2 wherein the first layer further comprises a second thermoplastic material different from the first thermoplastic material and blended therewith to form an alloy, the second thermoplastic material comprising a higher nylon polymer or copolymer.

6. The tube of claim 5 wherein the higher nylon polymer or copolymer is selected from the group consisting of nylon 11, nylon 12, and copolymers, blends, alloys, and combinations thereof.

7. The tube of claim 3, 4, 5, or 6 wherein the alloy comprises, based on the total weight of the first and the second thermoplastic material, between about 10-50% of the first thermoplastic material and between about 50-90% of the second thermoplastic material.

8. The tube of any of the preceding claims further comprising a tubular second layer concentric with the first layer, the second layer being bonded to the first layer and formed of a thermoplastic material the same as or different from the first thermoplastic material.

9. The tube of claim 8 wherein the thermoplastic material forming the second layer comprises a long-chain polyamide.

10. The tube of claim 9 wherein the long-chain polyamide is selected from the group consisting of nylon 4-10, nylon 6-10, nylon 10-10, nylon 6-12, nylon 10-12, nylon 12-12, and copolymers, blends, alloys, and combinations thereof.

11. The tube of claim 8 wherein the thermoplastic material forming the second layer comprises nylon 11, nylon 12, and copolymers, blends, alloys, and combinations thereof.

12. The tube of claim 8 wherein the thermoplastic material forming the second layer comprises an alloy of:
(a) nylon 4-10, nylon 6-10, nylon 10-10, nylon 6-12, nylon 10-12, nylon 12-12, or a copolymer, blend, alloy, or combination thereof; and
(b) nylon 11, nylon 12, or a co-copolymer, blend, alloy, or combination thereof.

13. The tube of claim 8, 9, 10, 11, or 12 wherein the second layer is the outermost layer of the article.

14. The tube of claim 8, 9, 10, 11, 12, or 13 wherein the first layer is the innermost layer of the article.

15. The tube of claim 8, 9, 10, 11, 12, or 13 wherein the first layer is an intermediate layer of the article.

16. The tube of any of the preceding claims wherein the article further comprises a tubular reinforcement layer concentric with the first layer, the reinforcement layer formed of one or more filaments of one or more fibers.
